(19) United States
(12) Patent Application Publication
(10) Pub. No.: US 2020/0174494 A1
(43) Pub. Date: Jun. 4, 2020

(54) Article Delivery System

(71) Applicant: Peter Lessels, Stratham, NH (US)

(72) Inventor: Peter Lessels, Stratham, NH (US)

(21) Appl. No.: 16/097,146

(22) PCT Filed: May 8, 2017
(86) PCT No.: PCT/US2017/031627

§ 371 Date: Oct. 26, 2018

Related U.S. Application Data
(60) Provisional application No. 62/333,781, filed on May 9, 2016.

(51) Int. Cl. G05D 1/02; G06Q 10/08; G06Q 10/06; G06Q 10/04; B60P 3/20; B60P 3/00; B60P 3/06

(52) U.S. Cl. CPC G05D 1/0291; G06Q 10/0836; G06Q 10/06316; G06Q 10/0832; G05D 2201/0213; B60P 3/20; B60P 3/007; B60P 3/06; G06Q 10/04

(57) ABSTRACT

An embodiment article delivery system, and corresponding method, includes a ground-based parent delivery vehicle and a plurality of child delivery vehicles configured to hold one or more articles for an article delivery to or from a customer location. The parent is configured to carry the child vehicles simultaneously, to transport them to at least one discharge location, and to discharge at least one of the child vehicles at discharge location. The child vehicle is configured to execute a hold instruction including waiting at a hold location following the discharge from the parent delivery vehicle. The child is further configured to navigate from the hold location to the customer location for the article delivery, the customer location differing from the hold location. Embodiment systems and methods can enable significant increases in product delivery efficiency or other article distribution efficiency.

### RELATED APPLICATION

This application claims the benefit of U.S. Provisional Application No. 62/333,781, filed on May 9, 2016. The entire teachings of the above application are incorporated herein by reference.

### BACKGROUND

Customers can order goods for delivery or pickup. Orders can include groceries, other products, dry cleaning, or many other items. A delivery time for an order is typically set so that the customer will be home and available at the delivery time. Autonomous road delivery vehicles have been proposed for delivery to try to increase efficiency. Another solution being explored for delivery includes using aerial delivery drones.

### SUMMARY

Delivering items to customers can still be quite expensive for a delivery company and inconvenient for the customer. Even though two customers may be located geographically close together, and even though both may be ordering goods from the same supplier or using the same delivery company, often the deliveries cannot be completed at the same time. Instead, often deliveries must be completed separately due to scheduling issues, such as one customer not being available around the same time as another customer. Even in cases where a delivery is to be immediate, a delivery person often spends extra time signaling to the customer that delivery has arrived, and the delivery person must wait for the customer to come to the door and then interact. Furthermore, even where products are dropped off with no interaction, there exist significant inefficiencies involved in delivering during busy traffic hours, as well as the risk of theft.

Prototype autonomous vehicles have had issues with not being able to navigate roads. They also have regulatory issues that are still being worked on. Furthermore, even if autonomous vehicles were used for delivery, they would still face limitations, in that a vehicle waiting for a customer would lose productivity, efficiency, and profitability and would face great uncertainty in when a delivery route could actually be completed, at least due to traffic and customer interaction issues.

Furthermore, while drones are an interesting prospective delivery method, drones have particular distance and capacity limitations based on battery capacity. Further, while ground-based carrier delivery systems have been proposed to carry smaller delivery vehicles, such systems still include many of the scheduling and efficiency problems of other delivery methods. Thus, existing solutions for delivery of products to customers are deficient in many ways.

Described herein are embodiment systems and methods that solve the problems described above by significant increasing potential delivery efficiency, optimizing customer interaction, and allowing a delivery vehicle to deliver more articles, such as products or other items to be delivered for any number of reasons, while avoiding congestion during high-traffic periods. Surprisingly, this result can be obtained by implementing significant waiting periods. In particular, parent delivery vehicle configured to carry a number of child delivery vehicles are described herein, which can either be a normal human driven vehicle or an autonomous vehicle. Embodiment parent delivery vehicles (parents) can transport two or more child delivery vehicles, particularly simultaneously until child vehicles are discharged. A child delivery vehicle can be fully autonomous, semi-autonomous, or fully remotely controlled.

When a parent delivery vehicle comes near a target delivery location, one or more child delivery vehicles can be released significantly prior to a desired delivery time, and this can be according to a schedule. A hold instruction can be executed by a child delivery vehicle, according to a schedule specifically designed for this purpose, to wait at a hold location prior to proceeding to a customer location for delivery of an article. The child delivery may then stop near where it was discharged and wait for the desired delivery time. Specifically, a hold location that is different from the customer location where a product is actually delivered may provide particular efficiencies where it is impossible or problematic to attempt to wait at the customer location where delivery is to occur. Alternatively, the child delivery vehicle may proceed to the customer meeting point at that location. For example, the child delivery vehicle may be released at the end of a long driveway early in the morning and wait for several hours before proceeding to customer location at a front door of a customer. Meanwhile, a parent delivery vehicle can be making many other deliveries of child vehicles, increasing efficiency.

In one embodiment, an article delivery system includes a ground-based parent delivery vehicle and a plurality of child delivery vehicles. The child vehicles are configured to hold one or more articles for an article delivery to or from a customer location. The parent delivery vehicle is configured to carry the plurality of child delivery vehicles simultaneously, at least until discharging one of the child vehicles. The parent is configured to transport the plurality of child delivery vehicles to at least one discharge location, and to discharge at least one of the plurality of child delivery vehicles at the at least one discharge location. The at least one child delivery vehicle is configured to execute a hold instruction that includes waiting at a hold location following the discharge from the parent delivery vehicle. The at least one child delivery vehicle is further configured to navigate, following waiting at the hold location, from the hold location to the customer location for the article delivery, the customer location differing from the hold location.

The at least one child delivery vehicle can be further configured to execute the hold instruction for an increase in an article delivery efficiency. The article delivery efficiency may be defined by either a number of article deliveries per hour per parent delivery vehicle or by a number of customer locations reached by the plurality of child delivery vehicles per hour per parent delivery vehicle. The article delivery can be a delivery of a product from the child delivery vehicle to the customer location or a delivery of a pickup article from the customer location to the at least one child delivery vehicle.

The at least one child delivery vehicle can be configured to execute the hold instruction at the hold location further with the hold location being the same as the at least one discharge location.

The system can further include a processor module configured to determine the hold instruction for the at least one child delivery vehicle. The processor module can be configured to be in direct or indirect operative communication with the child delivery vehicle for communication of the hold instruction to the at least one child delivery vehicle. The processor module may be cloud-based, or the processor module can be based in the parent delivery vehicle or in a distribution center.

The at least one child delivery vehicle can be further configured to receive the hold instruction dynamically in response to at least one of a change in a scheduled customer pickup time, an availability of a customer, a communication to or from the customer, a child delivery vehicle discharge schedule of the parent delivery vehicle, and a change in a pickup schedule. The article delivery can be a second article delivery subsequent to a first article delivery, and the at least one child delivery vehicle can be further configured to execute the hold instruction between the first and second article deliveries. The at least one child delivery vehicle can be further configured to complete at least two deliveries of articles, following the discharge, at respective, scheduled article delivery times, either at the same customer location or at least two respective customer locations.

The parent delivery vehicle may be human-operated, partially autonomous, fully autonomous, or remotely operated. The parent delivery vehicle may be configured to discharge the at least one child delivery vehicle further via a ramp, a crane, or a hydraulic lift. The plurality of child delivery vehicles may be partially autonomous, fully autonomous, or remotely controlled. The at least one child delivery vehicle may include a cooled or heated compartment.

The customer location or hold location may be a home, an apartment building, a business, an area surrounding a residential or commercial building, a lobby, a public space, a driveway, or a sidewalk.

The hold instruction may include waiting at the hold location for at least 15 minutes, for at least 30 minutes, for at least one hour, or for at least three hours prior to navigating to the customer location.

The parent delivery vehicle may be further configured to hold, transport, and discharge each of the plurality of child delivery vehicles, wherein the plurality of child delivery vehicles includes at least two, at least four, at least eight, or at least 10 child delivery vehicles or from two to four, from four to eight, or from eight to 20 child delivery vehicles, and wherein the parent delivery vehicle is further configured to pickup each of the plurality of child delivery vehicles following a discharge and article delivery corresponding to each respective child delivery vehicle.

The system can further include any system elements described hereinabove or hereinafter in connection with other embodiments.

In another embodiment, a method for article delivery includes transporting, simultaneously, via a ground-based parent delivery vehicle, a plurality of child delivery vehicles to at least one discharge location for an article delivery to or from a customer location. The method further includes discharging at least one of the plurality of child delivery vehicles from the parent delivery vehicle at the least one discharge location. The method further includes executing, via the at least one child delivery vehicle, a hold instruction including waiting at a hold location, following the discharging from the parent delivery vehicle. The method still further includes navigating, following the executing the hold instruction, via the at least one child delivery vehicle, from the hold location to the customer location for the article delivery, the customer location differing from the hold location.

The article delivery can be a product delivery, and the method can further include delivering the product, via the at least one child delivery vehicle, to the customer location. The article may be a pickup article to be received from the customer location, and the method can further include receiving the pickup article, via the at least one child delivery vehicle, from the customer location to the at least one child delivery vehicle.

Executing the hold instruction may include increasing an article delivery efficiency defined either by a number of article deliveries per hour per parent delivery vehicle or by a number of customer locations visited by child delivery vehicles per hour per parent delivery vehicle. Executing the hold instruction may include waiting at the hold location, further with the hold location being the same as the at least one discharge location.

The method may further include determining the hold instruction by a processor module, as well as communicating the hold instruction, directly or indirectly, from the processor module to the at least one child delivery vehicle. Determining the hold instruction can include using a cloud-based processor module, or the processor module may be based in the parent delivery vehicle or in a distribution center.

The method may further include receiving the hold instruction dynamically, at the at least one child delivery vehicle, in response to at least one of a change in a scheduled customer pickup time, an availability of a customer, a communication to or from the customer, a child delivery vehicle discharge schedule of the parent delivery vehicle, and a change in a child delivery vehicle pickup schedule for the parent delivery vehicle.

The article delivery may be a second article delivery subsequent to a first article delivery, and executing the hold instruction may include waiting at the hold location between the first and second article deliveries. The article delivery may be a first article delivery, the method further including completing a second article delivery, via the at least one child delivery vehicle, the first and second article deliveries occurring at respective, scheduled article delivery times, either at the same customer location or at two respective customer locations.

Transporting the plurality of child delivery vehicles can include transporting via at least one of a human-operated, partially autonomous, fully autonomous, or remotely-operated parent delivery vehicle. Discharging at least one of the plurality of child delivery vehicles may include discharging via a ramp, a crane, or a hydraulic lift of the parent delivery vehicle. Transporting the plurality of child delivery vehicles includes transporting at least one of a partially autonomous, fully autonomous, or remotely-operated child delivery vehicle. The method can further include heating or cooling, via the at least one child delivery vehicle, an article delivered or received.

Navigating to the customer location can include navigating to a home, apartment building, a business, an area surrounding a residential or commercial building, a lobby, or a public space. Executing the hold instruction can also include waiting at a driveway, a sidewalk, an area surrounding a residential or commercial building, or a public space. Executing the hold instruction may include waiting at the hold location for at least 15 minutes, for at least 30 minutes, for at least one hour, or for at least three hours before the navigating to the customer location.

Discharging can further include discharging each of the plurality of child delivery vehicles. Executing can further include executing, via each of the plurality of child delivery vehicles, a respective hold instruction including waiting at a respective hold location, following a respective discharging from the parent delivery vehicle, and navigating may further include navigating, following the executing the respective hold instruction, via each respective one of the child delivery vehicles, from the respective hold location to a respective customer location for a respective article delivery, each respective customer location differing from each respective hold location. The plurality of child delivery vehicles can include at least two, at least four, at least eight, or at least 10 child delivery vehicles or from two to four, from four to eight, or from eight to 20 child delivery vehicles, and the parent delivery vehicle may be further configured to pickup each of the plurality of child delivery vehicles following a discharge and article delivery corresponding to each respective child delivery vehicle.

The method can further include, or be modified by, any embodiment method elements described hereinabove or hereinafter in connection with other embodiments.

In yet another embodiment, an article delivery system includes a ground-based parent delivery vehicle and a plurality of child delivery vehicles. The child delivery vehicles are configured to hold one or more articles to be delivered for respective article deliveries to or from respective customer locations. The system also includes a processor module configured to provide a discharge schedule for the parent delivery vehicle according to one or more desired delivery times for the respective customer locations, wherein the parent delivery vehicle is configured to carry the plurality of child delivery vehicles simultaneously, for transport of the plurality of child delivery vehicles to respective discharge locations according to the discharge schedule, and to discharge the plurality of child delivery vehicles at the respective discharge locations according to the discharge schedule. The processor module is also configured to provide the discharge schedule to schedule the parent delivery vehicle to discharge at least one of the child delivery vehicles at the respective discharge location a significant time period prior to the desired delivery time for the respective customer location.

The significant time period can be at least 15 minutes, at least 30 minutes, at least one hour, or at least three hours. The at least one of the discharge locations may be the same as the respective customer location.

The system can further include any system elements described hereinabove or hereinafter in connection with other embodiments.

In still a further embodiment, a method for article delivery includes determining, by a processor module, a discharge schedule to schedule a ground-based parent delivery vehicle to discharge at least one of a plurality of child delivery vehicles at a discharge location a significant time period prior to a desired article delivery time for a corresponding customer location according to the discharge schedule. The method further includes transporting, simultaneously, via the parent delivery vehicle, the plurality of child delivery vehicles to be discharged at respective discharge locations for respective article deliveries to or from respective customer locations. The method also includes discharging the plurality of child delivery vehicles from the parent delivery vehicle at respective discharge locations, including discharging the at least one child delivery vehicle at least the significant time period prior to the desired article delivery time for the corresponding customer location according the discharge schedule.

The significant time period may be at least 15 minutes, at least 30 minutes, at least one hour, or at least three hours. Discharging can further include discharging one or more of the plurality of child delivery vehicles at the respective discharge location with the respective discharge location being the same as the respective customer location.

In yet another embodiment, an article delivery system includes a ground-based parent delivery vehicle and a child delivery vehicle configured to hold one or more articles for an article delivery to and from a customer location. The parent delivery vehicle is configured to carry the child delivery vehicle, to transport the child delivery vehicle to at least one discharge location, and to discharge the child delivery vehicle at a discharge location for delivery of the one or more articles at the customer location. The child delivery vehicle is configured to execute a hold instruction that includes waiting at the customer location following the discharge from the parent delivery vehicle and a delivery of an article to the customer location. The at least one child delivery vehicle is further configured to receive, following waiting at the customer location, one or more articles from the customer location.

The system can further include any system elements described hereinabove or hereinafter in connection with other embodiments.

In still another embodiment, a method for article delivery includes transporting, via a ground-based parent delivery vehicle, a child delivery vehicle to at least one discharge location for an article delivery to and from a customer location. The method further includes discharging the child delivery vehicle from the parent delivery vehicle at the discharge location. The method also includes executing, via the child delivery vehicle, a hold instruction including waiting at the customer location, following the discharging from the parent delivery vehicle and following a delivery of one or more articles to the customer location. The method still further includes receiving, following the executing the hold instruction, via the at least one child delivery vehicle, one or more articles for an article delivery from the customer location to the child delivery vehicle.

The method can further include, or be modified by, any embodiment method elements described hereinabove or hereinafter in connection with other embodiments.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a side view illustration of an embodiment article delivery system.

FIG. 1B is a schematic diagram illustrating example discharge, hold, customer, and pickup locations in which embodiment systems may operate.

FIG. 1C is a schematic diagram illustrating a network in communication with a cloud-based scheduling server with a processor module that can communicate with embodiment systems for delivery scheduling.

FIG. 1D is a modified version of FIGS. 1A, 1B, and 1C, further combined in schematic form to illustrate alternative navigation and communication environments in which an embodiment article delivery system may be configured to operate.

FIG. 2 is a more detailed illustration of the network shown in FIG. 1C, in which embodiment systems may operate for article deliveries.

FIG. 3 is a three-dimensional model of an embodiment child delivery vehicle.

FIG. 4 is a side view illustration of an embodiment article delivery system including a parent delivery vehicle with a crane for discharging child delivery vehicles.

FIG. 5 illustrates an embodiment parent delivery vehicle configured to operate on a sidewalk.

FIG. 6 illustrates an embodiment system operating in a residential environment with fiducial markers for child delivery vehicle navigation.

FIG. 7 illustrates an embodiment system operating in an environment of an apartment building.

FIGS. 8A, 8B, and 8C illustrate various hold instructions that may be executed by embodiment child delivery vehicles.

FIG. 9 is a flow diagram illustrating an embodiment procedure for article delivery including at least one child delivery vehicle executing a hold instruction at a hold location different from a customer location for article delivery.

FIG. 10 is a flow diagram illustrating an alternative embodiment procedure for article delivery including scheduling a child delivery vehicle for discharge a significant time period prior to a corresponding, desired article delivery time.

FIG. 11 illustrates example discharge schedules used by embodiments for discharge of a child delivery vehicle a significant time period prior to a respective, desired article delivery time.

FIG. 12 is a flow diagram illustrating a procedure for discharge and pickup of child delivery vehicles that can be performed consistent with embodiment systems and methods.

FIG. 13 is an illustration of an embodiment child delivery vehicle navigating through a building via an elevator.

FIG. 14 is a flow diagram illustrating an embodiment procedure for article delivery that includes delivering an article, executing the hold instruction, and receiving an article.

### DETAILED DESCRIPTION

A description of example embodiments of the invention follows.

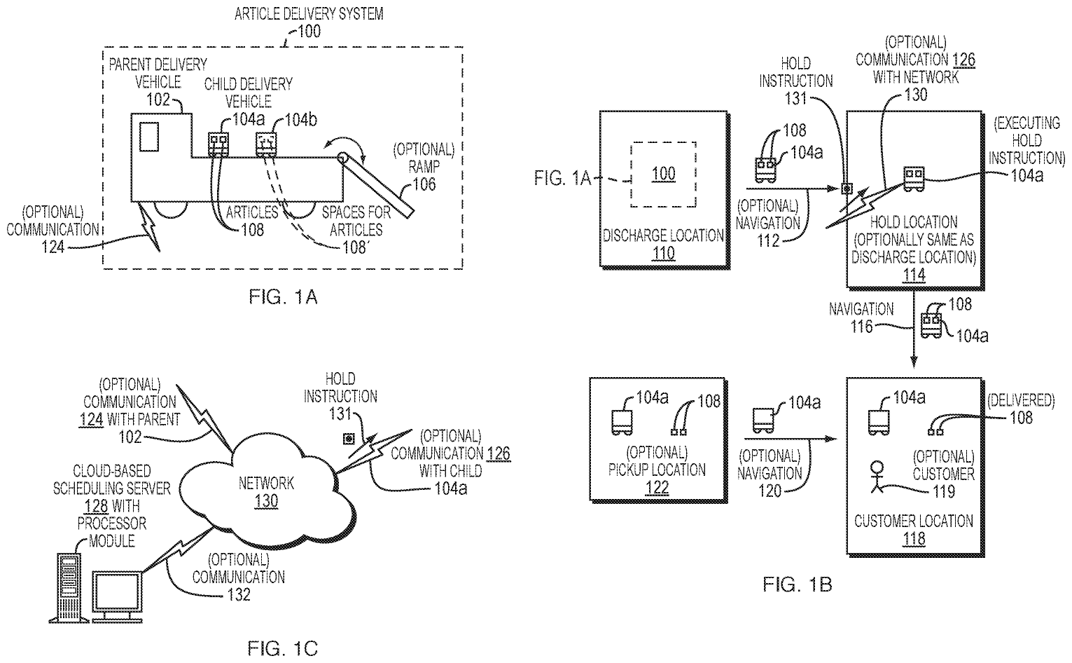

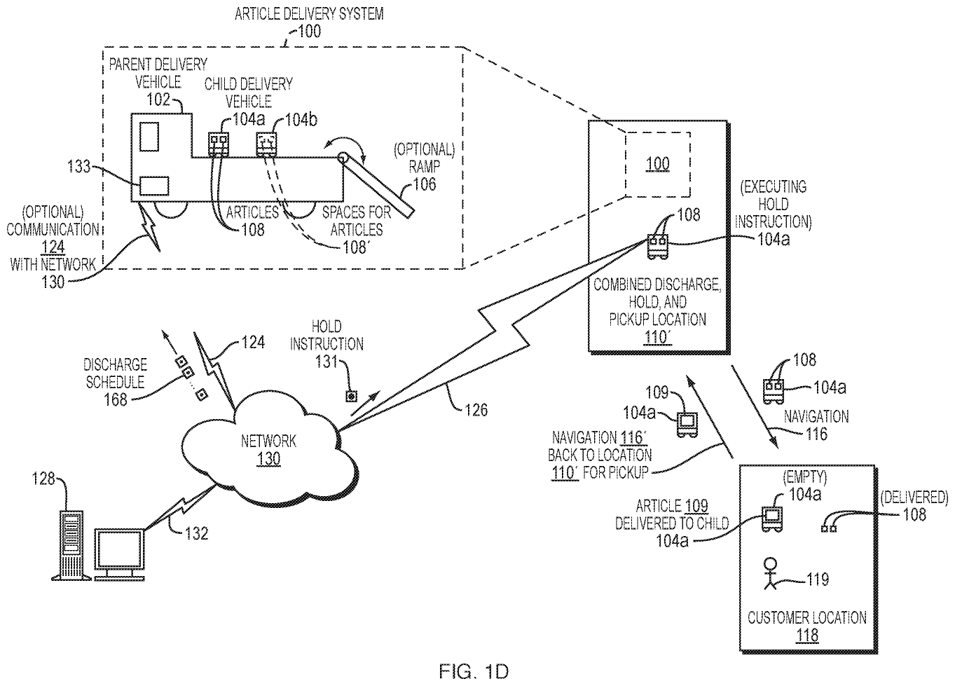

FIG. 1A is a side-view illustration of an embodiment article delivery system 100. The system 100 includes a parent delivery vehicle 102, as well as child delivery vehicles 104a and 104b. The parent 102 includes an optional ramp 106 for discharging child delivery vehicles from the rear of the parent 102 to a discharge location, as described hereinafter in connection with FIG. 1B.

In various embodiments, the parent 102 is configured to carry any plurality of child delivery vehicles simultaneously, including two or more child delivery vehicles, to transport them to one or more discharge locations. The parent 102 is also configured to discharge at least one of the plurality of child child vehicles at the discharge location.

“Discharge,” as used herein, indicates physically removing or releasing a child delivery vehicle from the parent, such that the child delivery vehicle is physically independent and separated from the parent and can be used to complete a delivery of an article, to or from the child delivery vehicle, with the parent 102 either presence or not present. In contrast, a “discharge schedule,” as used herein, can include one or more discharges, as well as one or more pickups of child vehicles, as well as hold instructions or other actions for parent or child vehicles, consistent with the remainder of the description herein.

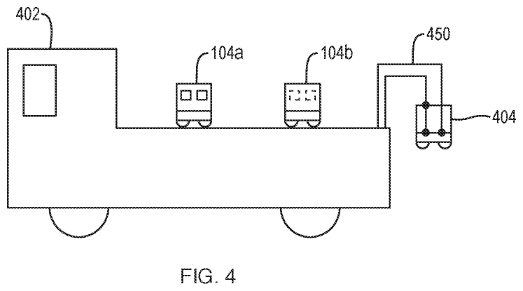

Discharge (removal) of a child delivery vehicle from the parent can be by any means, whether manual, automated, or semiautomated. In some embodiments, child delivery vehicles are configured to automatically navigate down the ramp 106, for example. In other embodiments, a person, such as a driver of the parent 102, can push a child down the ramp or otherwise remove a child. Furthermore, a ramp may be provided toward the side of apparent delivery vehicle or in any other direction from the parent 102 in order to allow discharge. Furthermore, other means of discharge are known and may be used, such as the crane-based discharge embodiment described in connection with FIG. 4.

Certain embodiments allow for discharge of child vehicles such that the child vehicles can be discharged onto private property and need not contact or navigate on public property independent of the parent delivery vehicle. In certain such embodiments, a parent vehicle may drive down a public street, park on the street, and deploy a ramp from the parent vehicle that extends over the street to a private driveway. The child vehicle may self-navigate or be pushed by an operator down the ramp and onto the private driveway to a hold location, and the child may further navigate along the driveway toward a private home, such the child need not navigate on public property. Avoiding a child vehicle navigating on public property can be advantageous for insurance and liability reasons, for example.

Each of the child delivery vehicles 104a and 104b is configured to hold one or more articles for an article delivery to or from a customer location. The child 104a, for example, is configured to hold articles 108 to be delivered from the child 104a to a customer location, and the articles 108 can be anything needing to be delivered, such as products, groceries, supplies, items serviced or requiring service, items to be returned to a manufacturer or to be mailed, laundry or dry cleaning to be cleaned, inventory to be transferred between commercial locations, etc.

The child delivery vehicle 104b includes one or more spaces 108′ that are configured to receive articles from customer locations. Articles received can include any of the articles 108 described above, for example.

“Customer,” as used herein, should be understood broadly to indicate any person, business, or entity, whether private, commercial, or public, that can deliver an article to, or receive an article from, a child delivery vehicle, either directly to or from the child delivery vehicle, or indirectly, by an article being delivered to a customer location, or picked up from era customer location, for example.

Moreover, “customer location,” as used herein, should be construed broadly to indicate any location, whether on private property, public or commercial property, or otherwise, where an article delivery to or from a child delivery vehicle for transfer to or pickup by a customer, whether directly or indirectly, may occur.

In various embodiments, the parent delivery vehicle 102 is human-operated. However, it may be partially autonomous, fully autonomous, or remotely operated. All of these types of operation of general vehicles are known in the art, and a person of ordinary skill in the art of human-operated vehicles, partially autonomous or fully autonomous vehicles, or remotely operated vehicles will readily understand how such vehicles may be designed and operated.

Parent delivery vehicles in various embodiments may include a trailer or flatbed configured to hold and transport one or more child delivery vehicles. Furthermore, various parent vehicles may be electric, gas powered, hybrid powered, etc. Furthermore, while the parent vehicle 102 illustrates the child vehicles 104a-b in the open air, it will be understood that in other embodiments, child vehicles may be enclosed within the parent 102, such as within a van or enclosed trailer pulled by a tractor, for example.

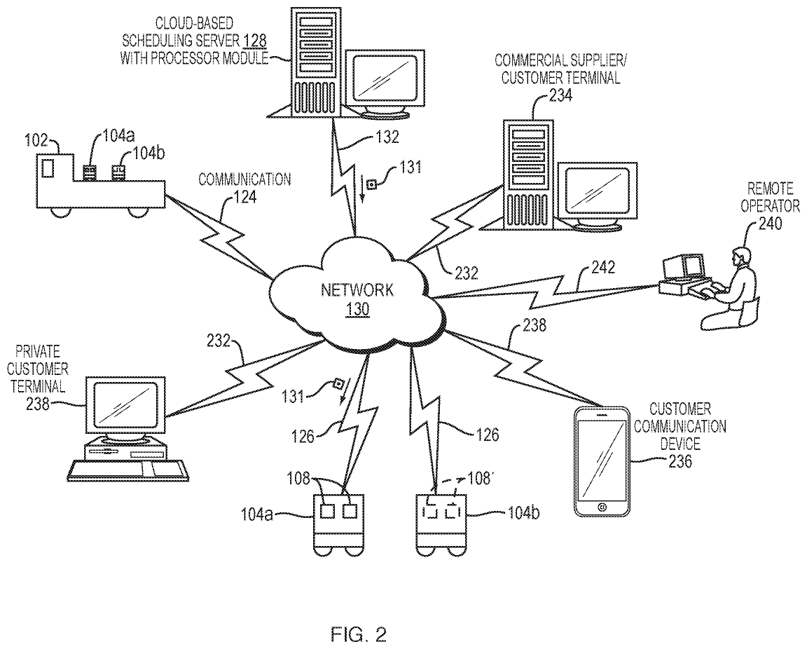

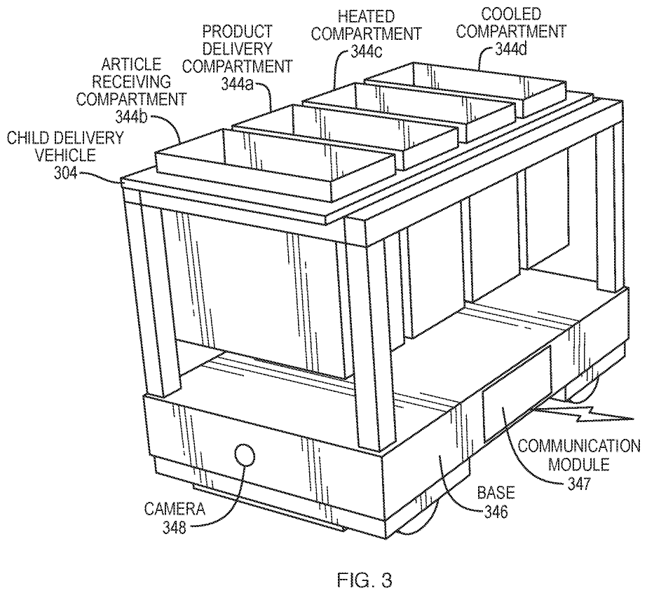

It should also be understood that in various embodiments, the child delivery vehicles may be partially autonomous, fully autonomous, or remotely controlled by a server, operator, or customer, for example. Remote control is further described in connection with FIG. 2, for example. Various other optional features of child delivery vehicles are described in connection with FIG. 3, for example.

As used herein, fully autonomous vehicles include vehicles that use sensors, computers, electronics, GPS signals, and the like to direct themselves during navigation without immediate human intervention. As also used herein, partially autonomous or semi-autonomous vehicles include vehicles that can direct themselves, partially or fully in the manner of autonomous vehicles, but can also be operated partly or fully with human assistance, such as in the case of a self-driving car that can be taken over by a human operator for complicated navigation or for emergencies or other purposes. As further used herein, human-operated vehicles include those that are driven, such as motor vehicles, or pushed or otherwise caused to move by direct human interaction or control. As further used herein, a remotely controlled vehicle is one that can be operated via a human or computer from a remote location not in direct physical contact with the vehicle. Examples of remotely controlled vehicles can include remotely controlled unmanned aereal vehicles (UAVs) whose surroundings are viewed by an operator via a video camera on the UAV. However, ground-based remotely controlled vehicles are also known. Remote control can include the human having visual contact with the vehicle, or it can include using cameras or other sensors on a child vehicle that permit a human to instruct the vehicle from remote location. An example camera on a child vehicle is described in connection with FIG. 3, for example.

Examples of self-driving vehicle technologies can be found in Wired, Oct. 25, 2016, “Uber's Self-Driving Truck Makes Its First Delivery: 50,000 Beers,” and in Don Melvin, CNN article Nov. 13, 2015, “Cop pulls over Google self-driving car, finds no driver to ticket,” for example.

As a separate matter from control means, power means of an autonomous, semi-autonomous, human operated, or remotely controlled vehicle may be by means of an electric motor, diesel motor, gas motor, natural gas motor, hybrid motor, and the like. Furthermore, some parent delivery vehicles within the scope of embodiments can be solely human-powered, in addition to being human-controlled (operator-controlled). An example semi-autonomous vehicle is describe in Russ Mitchell, Sep. 22, 2016, LA Times, “When robots and humans take turns at the wheel,” for example. Examples of remotely controlled vehicles are described in AutoEvolution, Oct. 19, 2015, “Australia Takes World's First Remote-Controlled Mine Trucks Online, Railway Next,” and Overdrive, “Remote-controlled trucks new automated transmission highlights zfs new product showcase,” for example.

FIG. 1B is a schematic, plan-view diagram illustrating various locations in which embodiment article delivery systems may operate, as well as example navigational movements that may be made by child delivery vehicles in embodiment systems. In particular, the parent 102 is configured to discharge at least one of the child vehicles 104a-b at a discharge location 110. The discharge location 110 can include a street, a sidewalk, a driveway, a parking lot, or any other location where a child delivery vehicle can be automatically or manually discharged from a parent vehicle.

The child vehicle 104a, holding articles 108, may be optionally configured to perform navigation 112 to a separate hold location 114 (also referred to herein as a “holding” location) to execute a hold instruction. The hold instruction includes waiting at the hold location, following the discharge from the parent vehicle. In other operational cases, the hold location 114 is the same as the discharge location 110, and the child executes the hold instruction at the discharge location, which is also the hold location. In such cases, the navigation 112 is not necessary.

The child 104a is also configured to perform navigation 116 from the hold location 114 to a customer location 118 that is different from the hold location 114. Article delivery of the articles 108 to the customer location 118 is depicted in FIG. 1B. However, as alternative, a child delivery vehicle such as a child 104b can receive articles at the customer location 118. Presence of a customer 119 at the customer location 118 is optional. Thus, delivery of articles may occur to or from a customer's agent or assistant, for example. Furthermore, delivery of articles to or from the customer location 118 can include depositing one or more articles 108 at the customer location with no person present. This may occur, for example, where a child delivery vehicle deposits groceries or other items at a customer driveway or porch.

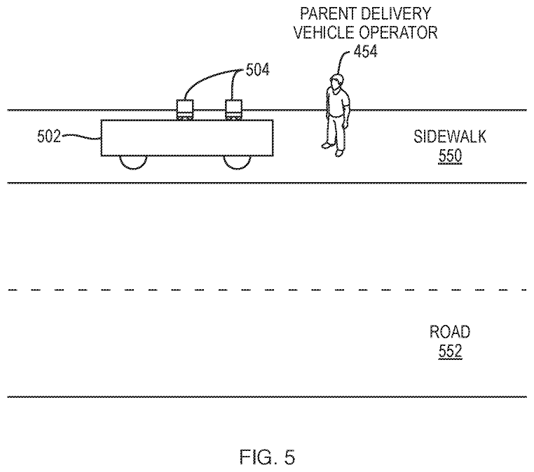

The child 104a may optionally complete an additional navigation 120 to a pickup location 122, where it may be received back into the parent delivery vehicle 100 at a later time. Alternatively, a pickup of the child 104a may optionally occur at the customer location, at the hold location, or the discharge location, with the child 104a navigating back to any location where the pickup is to occur. In various cases, the customer location 118 can be a home, sidewalk, driveway, an apartment building, a business, an area surrounding a residential or commercial building, a lobby, or a public space, for example. Furthermore, the hold location 114 can be any of those locations, and either the customer location or the hold location can be a driveway or a sidewalk, for example. Various example cases are described in connection with FIGS. 5, 6, and 7, for example.

As illustrated in FIGS. 1B-1C, a hold instruction 131, which the child vehicle is to perform at the hold location 114, may be received optionally via a communication 126. As illustrated in FIG. 1C, the communication 126 may, via a network 130, through a cellular network, Bluetooth signal, Wi-Fi signal, radio signal, or any other means of communication known, including a hard-wired communication with the parent or with a distribution facility from which the parent may be dispatched. Further, the hold instruction 131 can be received from a cloud-based scheduling server 128, which includes a processor module that is configured to determine the instruction for one or more child delivery vehicles.

The server 128 with processor module is in optional communication 132 with the network 130. The network 130 may also be in an optional communication 124 with the parent delivery vehicle 102. Hold instructions may come to a child delivery vehicle directly from the parent 102, such as via an Ethernet cable or thumb drive. Other alternatives include child delivery vehicles, or the parent delivery vehicle, receiving hold instructions for the child delivery vehicle at a distribution center, via either a wireless signal or a direct connection, for example. However, communication via the cloud is preferred, as hold instructions can be updated dynamically, in response to various factors. Some of these factors can include a change in a scheduled customer pickup time, and availability of a customer, a communication to or from a customer regarding anything such as a different order time or an additional or canceled order, a child delivery vehicle discharge schedule of the parent delivery vehicle, or any change in a pickup schedule for the parent delivery vehicle.

Where the optional communication 126 includes the child delivery vehicle communicating with the cloud via a wireless signal, for example, the child delivery vehicle can receive the hold instructions dynamically in response to anyone of these factors. A child delivery vehicle may include a communication module for communication with a customer, a parent delivery vehicle, a cloud-based scheduling server, a distribution center, and any other purpose. An example communication module is illustrated in FIG. 3.

Configuring child delivery vehicles to execute hold instructions at a hold location that is different from a customer location can significantly improve distribution or other article delivery efficiency. In a product distribution context, for example, article delivery efficiency may be defined by a number of article deliveries per hour, per parent delivery vehicle. As an example, a parent delivery vehicle responsible for delivering and picking up five child delivery vehicles at various locations will be able to deliver a certain number of products, via the five child delivery vehicles, per hour.

Where the child delivery vehicles, as in embodiments described herein, are enabled to execute hold instructions at the hold locations that are different from respective customer locations, significant efficiencies, and increased article delivery efficiency defined as above, can result. For example, a parent delivery vehicle need not experience rush-hour traffic, and can be scheduled to deliver child delivery vehicles in traffic-heavy areas prior to rush-hour, or after rush-hour has completed. If private customers are not yet prepared to receive, or to send articles via the child vehicles at an early hour before rush-hour, for example, child child vehicles may wait until a more convenient, scheduled time. Furthermore, where article deliveries are to or from a commercial entity, these deliveries may also occur during or after busy traffic periods, when businesses are open, the parent delivery vehicle need not experience the heavy traffic and can discharge (drop off) a child vehicle at an arbitrary time that is convenient in the context of the broader discharge schedule for a given system of parent vehicles and children vehicles with a given article discharge schedule.

Furthermore, in view of the description herein, it will be understood that hold instructions at hold locations that are different from respective customer locations provide many other advantages. For example, a hold location that is outside a lobby is helpful where a commercial or apartment lobby, for example, intended to serve as a customer location, opens at a time significantly later than a convenient discharge time for a parent and child combination.

Moreover, different locations for holding and article delivery can be helpful in many residential-type situations. For example, a curbside location for holding may be much more suitable than a driveway customer delivery location early in the morning, for example, because the driveway location may result in water damage to the child vehicle from sprinklers, disturbing the peace at the residence due to motion-activated lights or a donkey barking, for example, etc. Similarly, the end of a longer driveway may serve as a holding location early in the morning, while a porch or doorstep of the household may serve as the customer location for article delivery later in the morning, for example.

Accordingly, hold instructions executed by a child delivery vehicle can include waiting at the hold location for at least 15 minutes, for at least 30 minutes, for at least one hour, or for at least three hours prior to navigating to the customer location, for example. Furthermore, hold instructions can include waiting at the hold location for 5 to 15 minutes, 15 to 30 minutes, 30 minutes to one hour, one hour to three hours, or three hours to five hours prior to navigating to the customer location, for example. Furthermore any other hold times are possible, and a child delivery vehicle can be configured to enter a low-power state during such a holding period, or even receive power via onboard solar panels or a wayside charging station, for example, under appropriate circumstances.

FIG. 1D is a modified, combined version of FIGS. 1A, 1B, and 1C illustrating alternative navigation and communication environments in which the article delivery system 100 can be configured to operate. In FIG. 1D, the parent vehicle 102 still discharges the child vehicle 104a at a discharge location. However, in FIG. 1D, the location is a combined discharge, hold, and pickup location 110′. This illustrates that the child delivery vehicle can be configured to execute the hold instruction 131 at the same location as where the child vehicle 104 is discharged from the parent 102, as further described hereinabove. After executing the hold instruction, the navigation 116 to the customer location 118 occurs, followed by delivery of the articles 108 to the customer location.

Further in FIG. 1D, the child vehicle 104a also receives an article 109 delivered from the customer location 118 to the child 104a. Thus, delivery also includes a delivery from the customer location to the child vehicle. This delivery optionally includes interaction with the customer 119, or another person such as a customer agent. Further, the delivery of the article 109 to the child may not include a person at the customer location, as further described herein in connection with other figures. In particular, delivery of the article 109 to the child 104a may be by means of a robotic arm either on the child 104a or installed at the customer location, or any other means known in the art of automation and product pickup.

Following receipt of the article 109, the child 104a, carrying the article 109, navigates, as shown by the navigation arrow 116′, back to the location 110′ for pickup by the parent delivery vehicle 102. Combined pickup and discharge locations can include a curbside, a driveway, a hotel lobby, the surroundings of an apartment building, or any other location or equivalent location described herein, among others. A combined discharge and pickup location is particularly useful because it is often most convenient for a parent delivery vehicle to access the same location for pickup and delivery in many neighborhoods, regions, and environments.

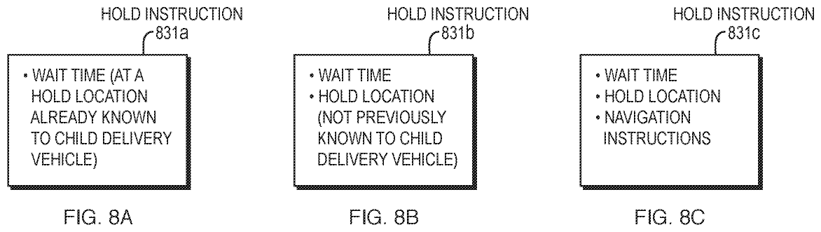

FIG. 1D also illustrates the hold instruction 131 being communicated via communication 126 from the network 130 to the child delivery vehicle. As described elsewhere herein, hold instructions can be received by a child delivery vehicle either before discharge, such as on the parent delivery vehicle 102 or in a distribution center, or after discharge, such as at a location 110′, even where the location 110′ may already be known to the child 104a. Furthermore, hold instructions can be communicated to a child delivery vehicle non-wirelessly, via connection to an Ethernet cable, for example. Moreover, hold instructions may be communicated to a child delivery vehicle at any location. For example, additional hold instructions may be received at the customer location for holding for longer period of time at the customer location based on dynamic factors described elsewhere in this application. A hold instruction, or revised hold instruction, or other article delivery instructions, may be received at a child delivery vehicle during the navigation 116′, or while waiting at a hold or pickup location, or both. Various example hold instructions are illustrated and described hereinafter in connection with FIGS. 8A-8C.

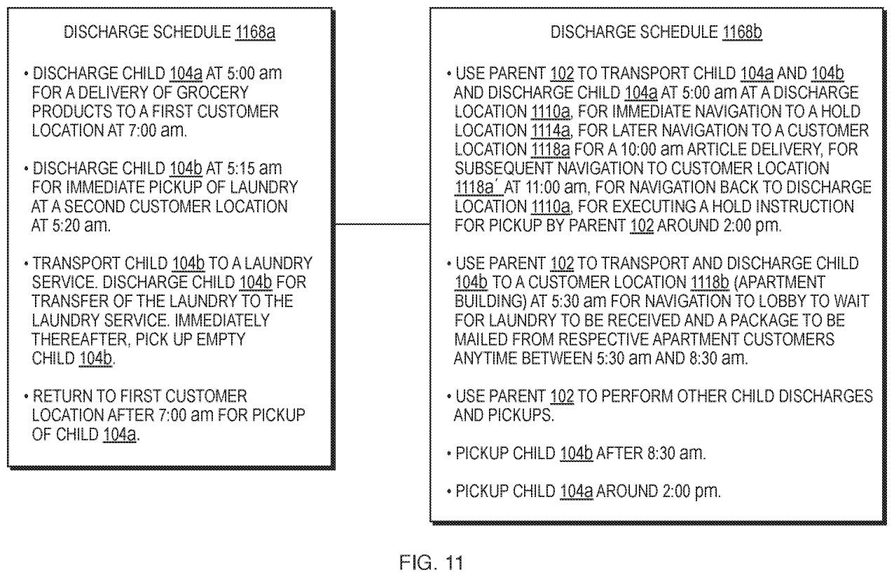

Further illustrated in FIG. 1D is that the communication 124 between the network and the parent vehicle 102 can include an optional discharge schedule 168. The discharge schedule 168 can include locations, times, mapping information, and any other information related to a schedule for discharging child delivery vehicles at various locations, for example. Furthermore, discharge schedules may include pickup information, such as where or when to pick up child delivery vehicles, including any dynamically changing information, as described elsewhere herein. Example discharge schedules are illustrated and described in connection with FIG. 11, for example. Communications with the parent 102 may be via a communication module 133 either built into the parent vehicle 102, or a mobile communication device, such as a cell phone in possession of a parent vehicle driver, where a parent vehicle includes an operator and is not fully autonomous, for example.

The communication 124 can include, in addition to the discharge schedule 168, one or more hold instructions 131 to be communicated from the parent vehicle 102 to the child vehicles 104a and 104b. Accordingly, as used herein, “discharge schedule” includes discharge information for apparent vehicle to discharge one or more child delivery vehicles. However, a “discharge schedule” may also include pickup information in order to pick up child delivery vehicles, and a discharge schedule may also include hold instructions, such as those illustrated in FIGS. 1C, 1D, and 8A-8C, where these hold instructions are to be communicated to the child vehicles via the parent, for example.

FIG. 2 is a schematic diagram illustrating, in further detail, the network 130 illustrated in FIG. 1C. Embodiment systems and methods may operate in such a network environment, for example. The network includes the cloud-based scheduling server 128, with processor module therein, that is configured to determine hold instructions for child delivery vehicles, such as the child vehicles 104a and 104b on the parent 102. Furthermore, the server 128 can be configured to determine discharge schedules for the parent vehicle to discharge, pick up, or both discharge and pickup child vehicles, in addition to the hold instructions 131. The communication 132 between the cloud-based server 128 and the network 130 can be bought via any means known, including Ethernet, wireless communication protocols and hardware, etc.

The parent 102 is also in communication 124 with the network 130 in FIG. 2, and the parent 102 may include a communication module (not illustrated in FIG. 2), for this purpose. Communication 126 may also occur between the child vehicles 104a-b, whether on the parent 102 or separated therefrom, via any known communication means, and such communication is preferably wireless for receiving hold instructions 131, any dynamically changing instructions for navigation, or for remote control of the child delivery vehicles 104a-b by a remote operator 240.

The remote operator 240 can control the child vehicles via communication 242 with the network 130. In some embodiments, for example, child vehicles include cameras and other sensors that can provide images, via the network, to the remote operator 240. The operator 240 then determines motion or other commands to be provided to the child vehicles for operation. The remote operator 240 can even cause the hold instruction to be executed by the child vehicles 104a-b, for example.

A commercial supplier/customer terminal 234 is also illustrated, which is in communication 232 with the network 130. The terminal 234 can be used to place commercial orders for articles to be delivered to or from child delivery vehicles for further transfer or distribution, for example. Similarly, a private party may use a private customer terminal 238, such as a home computer or tablet, via communication 232 with the network 130, to place customer orders such as purchasing products or requesting services that may be provided by child delivery vehicles. In addition, any number of customer communication devices 236 may be in communication 238 with the network to place orders, receive information about orders, etc. Such customer communication devices can include tablets, smart phones, laptop computers, or any other customer device, whether private or commercial, for communicating with the network.

FIG. 3 is a three-dimensional model of an example embodiment child delivery vehicle 304. The child 304 has various compartments 344a-d for various purposes, illustrating particular functions that can be performed by various embodiments. For example, a product delivery compartment 344a can be used to deliver a product to a customer, whether private or commercial, at a customer location. In conjugate fashion, an article receiving compartment 344b includes capacity for delivery of an article from a customer to the child 304, such as an item to be mailed, a product to be returned to a manufacture, an item requiring service by a manufacturer, laundry or dry cleaning to be cleaned by a service provider, etc. A commercial entity may place a product in the article receiving compartment 344b for delivery to a customer, for example.

The child 304 also includes a heated compartment 344c for delivering hot items, such as freshly cooked food, to customers. The child 304 also includes a cooled compartment 344d that can be used for delivery of cold items, such as milk, meats, frozen items, etc. The cooling and heating may be provided via a refrigeration or heating system, or passively through cooling or heating packs, for example. Embodiment child delivery vehicles can be kept at temperature while on a parent delivery vehicle actively, for example, followed by temperature maintenance passively, via insulation, once a child vehicle is discharged from a parent vehicle.

The multiple compartments 344a-d can assist for child delivery vehicles that hold more than one order for the same or different customers. This means that a given child delivery vehicle may navigate to multiple customer locations on a single trip following discharge. Furthermore, a child delivery vehicle may deliver one or more products to a first customer, while a second customer may drop off items into that (now empty) compartment space in the child vehicle. In various embodiments, compartments, or other features of a child delivery vehicle can hold one or more products, items, bags, boxes, or other articles that a customer can retrieve or deposit as part of an article delivery.

As shown in FIG. 3, the child 304 includes a camera 348 for navigation, and the camera 348 may be used for automated self navigation for an autonomous child, or for remote control via the operator 240 illustrated in FIG. 2, for example. Furthermore, as will be understood by those of ordinary skill in the art of semi-autonomous or autonomous vehicles, the child delivery vehicle 304 may also include other types of sensors, communication features, or other features that facilitate navigation. The embodiment of FIG. 3 includes a base 346 that houses batteries, a communications module 347, and computerized control systems. While the child delivery vehicles are on the parent delivery vehicle, they may receive power through contacts or induction. This can allow the child delivery vehicles to charge their batteries and not use battery power while on the parent. The communications module 347 can perform the communications 131 illustrated in FIGS. 1B, 1C, and 1D, as well as communications with a customer or customer location.

FIG. 4 is a side-view illustration of an embodiment parent delivery vehicle 402 that includes a crane 450. The crane 450 is configured to remove a child delivery vehicle 404 discharge from the parent 402, it will be recognized by those skilled in the art that various other means for discharging, or receiving (picking up) child vehicles back into the apparent vehicle may be provided. Some of these have been described hereinabove. Furthermore, other embodiments use a hydraulic lift or other types of systems for automated, manual, or semiautomated discharge and pick up of child delivery vehicles.

FIG. 5 is an illustration of yet another embodiment parent delivery vehicle 502 that is configured for use on a sidewalk 550. Accordingly, ground-based parent delivery vehicles described herein need not be road- (street-) based, such as a delivery truck. In particular, the parent vehicle 502 can be manually operated by a parent delivery vehicle operator 454, who can push or pedal the parent vehicle. The parent vehicle 502 can alternatively be powered by an electric or gas motor, for example. Child delivery vehicles 504 that the parent 502 is configured to transport and discharge can be autonomous, semi-autonomous, or manually operated.

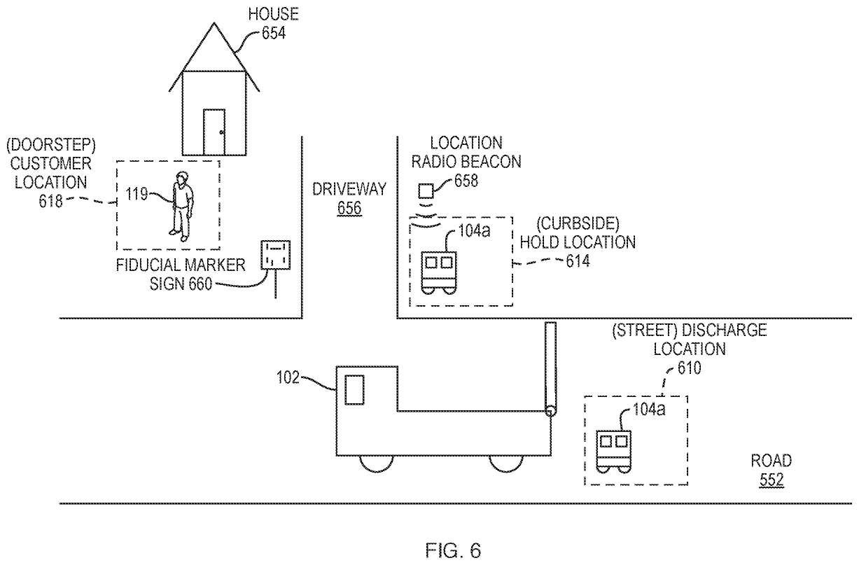

FIG. 6 is an illustration of the parent vehicle 102, also described in connection with FIG. 1A, in a residential environment including a house 654 with a driveway 656 next to a road 552. The parent vehicle 102 discharges the child 104a at a street discharge location 610. After discharge, the child 104a navigates to a curbside hold location 614 to execute a hold instruction that includes waiting at the hold location 614. After execution of the hold instruction, the child 104a proceeds to a doorstep customer location 618 near the doorstep of the house, via the driveway 656. In FIG. 6, the optional customer 119 meets the child delivery vehicle 104a at the customer location 618.

Hold locations, in various embodiments, may be specified by a parent vehicle driver before or after discharge of the child delivery vehicle and included in a hold instruction to the child vehicle 104a. As an alternative, a hold location, as well as a customer location for article delivery, can be set by the customer 119 in advance. This can be done with location on a satellite map at the private customer terminal 238 or communication device 236 illustrated in FIG. 2, for example.

FIG. 6 also illustrates two other aids that can be used for specification of hold or customer locations, including a location radio beacon 658 and a fiducial marker sign 660 that can be provided in the vicinity of the house 654. The fiducial marker sign 660 is a visual sign that can be recognized by the child delivery vehicle 104a, using the camera 348 with onboard machine vision capability, for example. Other means for specifying a customer location or hold location can include a parent vehicle operator, or the remote operator 240 illustrated in FIG. 2, setting a heading and distance or path for the child delivery vehicle. For example, as described hereinabove, the remote operator 240 may use images provided by the camera 348 illustrated in FIG. 3 on a child delivery vehicle to mark a position to which the child vehicle should navigate. This can be a very efficient way to control child delivery vehicles remotely, because the remote operator 240 may operate different child delivery vehicles at different times to assist them in navigating before or after holding periods, for example.

In the embodiment of FIG. 6, or in any other embodiment described herein, the customer 119 may be notified of the status of a child delivery vehicle. For example, the customer 119 may be immediately informed when the child 104a has arrived at the hold location or the customer location, or even the discharge location. The notification may be by email, phone, notification in an application, phone message, or by another means of notification or communication. The notification may be sent from a central system, such as the cloud-based scheduling server 128 illustrated in FIGS. 1C and 2. Alternatively, the notification may be sent from the child vehicle 104a or by the parent vehicle 102.

The notification may not occur until a time set for the article delivery. For example, the customer 119 can request an 8:00 AM delivery during an order. However, for efficiency of delivery, the child delivery vehicle can be discharged from the parent at 6:00 AM. However, after a hold period is executed at a holding location, the customer 119 may be alerted at 8:00 AM, the expected delivery time at the customer location.

In other cases, embodiments can be configured to perform alerting of the customer in stages. For example, an email notification can be provided when the child vehicle arrives (e.g., at 6:00 AM), followed by an application notification at the expected article delivery time at the customer location (e.g., at 8:00 AM), followed by an SMS at 8:15 AM to notify the customer that delivery is overdue, followed by a phone call at a further overdue time (e.g. 8:30 AM).

At a particular time, the child vehicle moves from the hold location to the customer location. A customer may actually trigger this navigation to the customer location from the hold location by using an ordering application or website, for example. Alternatively, the customer may signal the child delivery vehicle using a screen or other interface on the child delivery vehicle itself. When the customer is ready to remove items from, or deposit items into, a child delivery vehicle, the customer can signal this by using a touch screen, pushbuttons, or other interface on the child delivery vehicle in other embodiments, if desired, a child delivery vehicle may detect a Bluetooth or other signal from a customer's phone. Alternatively, a customer may enter a code that has been prearranged for the order when the order was placed.

Once a customer has finished the necessary interaction with the child delivery vehicle for article delivery, the customer may press a button on the child vehicle to indicate that the customer has completed the process. A child delivery vehicle may automatically detect that a customer is finished, alternatively, based on an access door of the child vehicle being opened and then closed. As a further alternative, a customer may use an application, or send a phone message, to inform a planning server, or the child vehicle directly, that the customers pickup or drop-off of articles is complete. At that point, the child delivery vehicle can move to a pickup location, as described in connection with FIG. 1B.

A pickup location can be the same as the customer location, or the same as a hold location, or the same as the discharge location, depending on the circumstances and area. A parent delivery vehicle, whether the same one that discharged the child, or a different parent delivery vehicle that may be more available at the time, may be dispatch either immediately or when there are enough pickups of child vehicles in a region to warrant a trip.

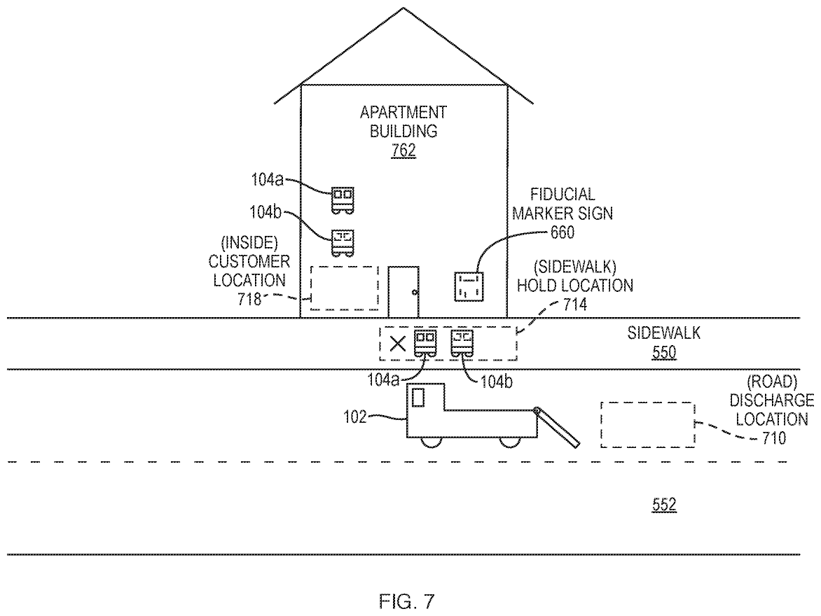

FIG. 7 is an illustration of the parent 102 and child delivery vehicles 104a-b operating in the vicinity of an apartment building 762. In FIG. 7, a road discharge location 710 on the road 552 is used by the parent 102. The child vehicles 104a-b then navigate to a sidewalk hold location 714 on the sidewalk 550. Similar to the description provided in connection with FIG. 6, the child vehicles use the fiducial marker sign 660, which is placed on the apartment building 762 in this case.

After executing a hold instruction that includes the child vehicles 104a-b waiting at the hold location 714, the child vehicles 104a-b navigate to a customer location 718 inside a front entry of the apartment building 762. As described above, this can be helpful where a private, public, or commercial building does not open for a certain amount of time after discharge. Once inside, at the customer location 718, the child vehicles on 104a and 104b can wait for article deliveries from and to the child vehicles, respectively, at the same or respective times by either the same customer or by respective customers.

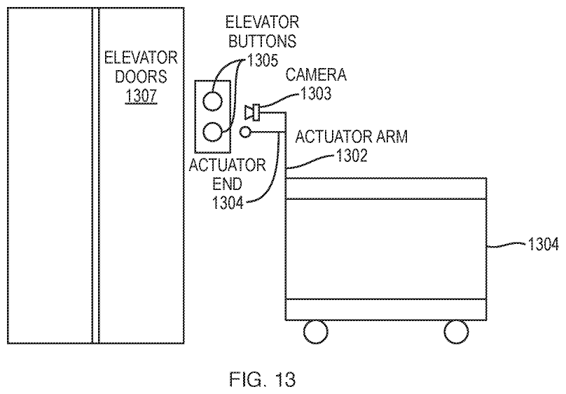

Furthermore, while the outside, sidewalk hold location 714 is illustrated in FIG. 7, with the customer location 718 for delivery being inside the lobby of the apartment building, in other cases, it embodiments can use the inside of a building for a holding location, followed by self-navigating or being remotely controlled or otherwise human-assisted to a different location in a building, such as a particular room or apartment, for the customer location and article delivery. An example embodiment including certain features for navigating in a building via an elevator is described hereinafter in connection with FIG. 13.

FIGS. 8A-8C illustrate various example hold instructions that can be executed using an embodiment child delivery vehicles. In particular, FIG. 8A shows a hold instruction 8:31 AM, which includes only a wait time (hold time). This type of instruction can be used where a child delivery vehicle already has a hold location that is known, for example. This type of hold instruction may further be useful where a hold location is not changed, but a wait time is either initially unknown, or changes dynamically for some reason. For example, a customer may indicate, via the communication 232 or 238 illustrated in FIG. 2, for example, that the customer prefers to proceed with an article delivery and an earlier time than's previously scheduled, or that the customer will no longer be available at the scheduled time and will be delayed.

In the case of preceding early with an article delivery, a child vehicle may be triggered to terminate the wait and proceed to navigate to the customer location from the hold location, for example. Furthermore, a child vehicle may be given an instruction to skip a particular wait time at a holding location altogether, thus proceeding directly from a discharge location to a customer location, for example.

FIG. 8B illustrates an alternative hold instruction 831b that includes both wait time and hold location, where the hold location is not previously known to the child delivery vehicle, for example. This type of hold instruction may be useful either where no instructions for holding have previously been provided to the child vehicle, or where both a hold time and location had changed dynamically due to one or more of the circumstances described herein above. The hold instruction 831b can be provided to a child delivery vehicle, either directly from a scheduling server through the network 130, or via a communication from a parent vehicle, or even directly from a customer in some cases, for example.

FIG. 8C illustrates a hold instruction 831c that is similar to the hold instruction 831 be shown in FIG. 8B, except that the instruction 831c further includes navigation instructions for navigation to the hold location. Any one of the hold instructions 831a-c can be provided to a child delivery vehicle at the beginning of the day or during the course of a delivery route while being transported by the parent vehicle, or while separated from the parent vehicle, for example.

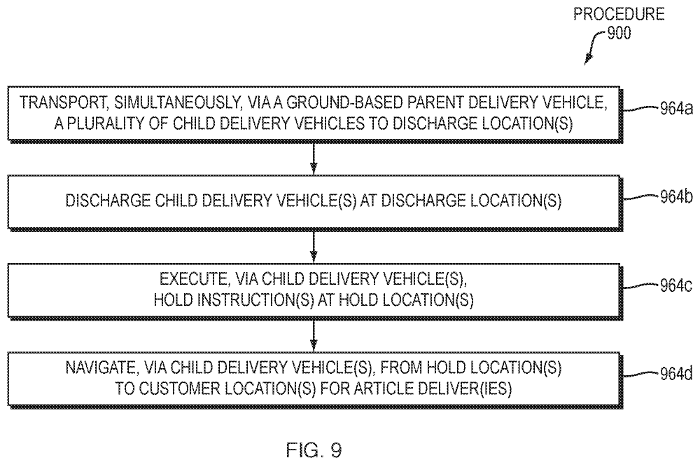

FIG. 9 is a flow diagram illustrating an embodiment procedure 900 for article delivery that can be performed using embodiments, and in network environments and example physical locations described herein above. At 964a, a plurality of child delivery vehicles is transported, simultaneously, via a ground-based parent delivery vehicle, to at least one discharge location for an article delivery to or from a customer location.

At 964b, at least one of the plurality of child delivery vehicles is discharged from the parent delivery vehicle at the at least one discharge location. At 964c, a hold instruction, including waiting at a hold location, is executed via the at least one child delivery vehicle following the discharging from the parent delivery vehicle. At 964d, navigating is performed, following the executing the hold instruction, via the at least one child delivery vehicle, from the hold location to the customer location for the article delivery, the customer location differing from the hold location.

As described hereinabove, executing the hold instruction can result in an increase in article delivery efficiency. Article delivery efficiency can be defined by a number of article deliveries per hour per parent delivery vehicle. The article delivery can be a product delivery, and the method can further include delivering the product, via the at least one child delivery vehicle, to the customer location. As further described hereinabove, executing the hold instructions, including waiting at the hold locations prior to navigating via the child delivery vehicles two respective customer locations, can result in significant efficiencies in delivery, particularly in the context of a parent-child delivery system.

The article delivery can be a product delivery, as described in connection with FIG. 1, for example. The method can further include delivering the product, via the at least one child delivery vehicle, to the customer location. The article, in contrast, can be a pickup article to be received from the customer location, and the method can further include receiving the pickup article, via the at least one child delivery vehicle, from the customer location to the child vehicle.

In some cases, executing the hold instruction can include waiting at the hold location with the hold location being the same as the discharge location, as described in connection with FIG. 1, for example.

Furthermore, as described in connection with FIGS. 1C and 2, the hold instruction can be determined by a processor module, such as the processor module in the cloud-based scheduling server 128. The method can include communicating the hold instruction, whether directly to the child vehicle or indirectly through the parent delivery vehicle or another route, via the network 130 illustrated in FIGS. 1C and 2, or by other communication means. The hold instruction being determined can include using the cloud-based processor module, or the processor module can be based in the parent delivery vehicle or in a distribution center, such as a center from which the parent delivery vehicle is dispatched.

As described hereinabove, hold instructions may be received at the child delivery vehicle dynamically, in response to various circumstances. Some of these circumstances can include a change in a scheduled customer pickup time, a change in availability of a customer, a communication to or from a customer, whether directly between the customer and child delivery vehicle or between the customer and the cloud-based scheduling server 128 or otherwise. Further circumstances where dynamic hold instructions may be useful are where a child delivery vehicle discharge schedule from the parent delivery vehicle needs to be modified based on an additional order received, or another circumstance on a delivery route, such as a change in circumstances of another child delivery vehicle that requires more immediate pickup, service, or requires more hold time. Furthermore, a change in a child delivery vehicle pickup schedule for the parent delivery vehicle may also result in hold instructions executed by the child vehicle changing dynamically.

Multiple deliveries can be performed by a single child delivery vehicle after discharge, as described hereinabove. Executing the hold instruction can include waiting at the hold location between first and second article deliveries, with the second article delivery subsequent to the first article delivery. Thus, a child delivery vehicle may complete a first article the delivery immediately after discharge, while it may be helpful to wait at a hold location prior to a second delivery.

In various embodiment methods, two or more article deliveries can be completed via a single child delivery vehicle, even when the first and second article deliveries occurring at respective, scheduled article delivery times, whether at the same customer location, or at two respective customer locations, as described herein above. Respective customer locations can be on the same street, in the same neighborhood, in the same commercial area, and the like.

Furthermore, two article deliveries can be performed by a single child delivery vehicle at the same customer location but with respect to two different customers. The two different article deliveries can occur in the apartment building 762 in FIG. 7, for example. Such article deliveries, even by a single child vehicle, can include both delivering the product for other article to a customer from the child vehicle, as well as receiving an article from a customer to the child vehicle, and similar or different article compartments in the child vehicle can be used for this purpose.

Transporting the plurality of child delivery vehicles can include transporting via a human-operated, partially autonomous, fully autonomous, or remotely operated parent delivery vehicle, as described in connection with FIGS. 1 and 5, for example. As part of discharging a child delivery vehicle, a ramp or crane, as described in connection with FIGS. 1A and 4, for example, may be used. Alternatively, discharge may be manual by a parent delivery vehicle operator, or by means of a hydraulic lift on the parent delivery vehicle, for example.

As described hereinabove, a parent delivery vehicle may transport a variety of different types of child delivery vehicles with different degrees of autonomous operation, such as partially autonomous child vehicles, fully autonomous child vehicles, or remotely operated child delivery vehicles operated by a remote operator, such as the operator 240 described in connection with FIG. 2, for example.

Heating or cooling can be performed by a child delivery vehicle, as described in connection with FIG. 3, whether passive or active heating or cooling. Further as described herein above in connection with FIG. 1B, for example, as well as other figures, navigating to a customer location can include going to a home, apartment building, business, an area surrounding a residential or commercial building, a lobby, or a public space, as well as navigating to a driveway or sidewalk. Hold locations can include any of the above locations as well, and hold instructions can include waiting at the hold location for at least 15 minutes, 30 minutes, one hour, or three hours before navigating to the customer location.

It will further be recognized, in view of the description herein, that each of a plurality of child delivery vehicles held and transported by a parent vehicle can be discharged, whether at the same discharge location or respective discharge locations. Each child vehicle can further execute a respective hold instruction at a respective hold location, following a respective discharging from the parent vehicle. Each child delivery vehicle can then navigate to a respective customer location for a respective article delivery, each respective customer location different from each respective hold location. A parent delivery vehicle may transport any number of child delivery vehicles for these purposes, including at least two, at least four, at least eight, for at least 10 child delivery vehicles. Furthermore, some parent vehicles within the scope of embodiments are configured to transport, simultaneously, from 2 to 4, from 4 to 8, from 8 to 20, or more than 20 child delivery vehicles, and the parent delivery vehicle can be configured to pick up each of the child delivery vehicles following a discharge an article delivery corresponding to each child delivery vehicle, as described in connection with FIGS. 1A-1C, for example.

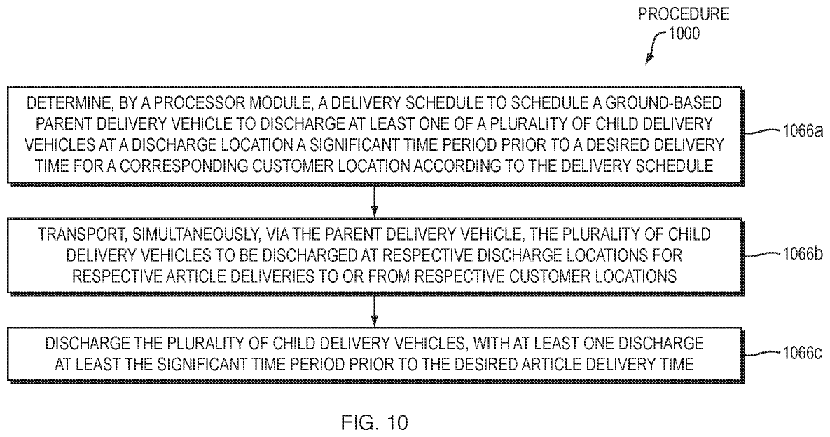

FIG. 10 is a flow diagram illustrating an alternative embodiment procedure 1000 that can be performed using embodiment systems, and in the example environments described herein above. In particular, as part of the procedure 1000, it is not necessary for a hold location to be different from a customer location. A hold instruction can be executed by a child delivery vehicle at a customer location according to a discharge schedule that causes child delivery vehicles to be discharged a significant time. Prior to a desired delivery time. The significant time periods can be at least 15 minutes, at least 30 minutes, at least one hour, or at least three hours, or in particular it time. Ranges between any two of these example values, such as in a range of 15 to 30 minutes, from 30 minutes to one hour, from one hour to three hours, or from three hours to larger values, such as five hours, 10 hours, 12 hours, or more.

In particular, in the procedure 1000 in FIG. 10, at 1066a, a discharge schedule is determined by a processor module such as the module in the cloud-based scheduling server 128 illustrated in FIGS. 1C and 2, for example. The discharge schedule specifically schedules a ground-based parent delivery vehicle to discharge at least one of a plurality of child delivery vehicles at a discharge location a significant time. Prior to a desired article delivery time for a corresponding customer location according to the discharge schedule. At 1066b, the plurality of child delivery vehicles is transported by the parent delivery vehicle, simultaneously. This simultaneously transportation should be understood to include a segment of a parent delivery vehicles route in which it is carrying the plurality of child delivery vehicles. While the child delivery vehicles are to be discharged at respective discharge locations for respective article deliveries to or from respective customer locations, the transporting will not be simultaneous for all segments of a parent vehicles route, but only for part of its route due to discharge of child vehicles at respective locations.

At 1066c, the plurality of child delivery vehicles is actually discharged from the parent delivery vehicle at respective discharge locations, including at different times. This discharging includes at least one child delivery vehicle being discharged at least the significant time prior to the desired article delivery time for the corresponding customer location according to the discharge schedule. Furthermore, in some embodiments, two, more than two, or all of the child delivery vehicles are discharged at respective discharge locations significant time periods prior to respective, desired article delivery times. As will be understood in view of the other description contained herein, the discharging of child delivery vehicles significant times prior to respective article delivery times can result in significant efficiencies in an overall discharge schedule for a parent vehicle.

Accordingly, consistent with embodiments encompassed by the procedure 1000, child delivery vehicles can be configured to execute hold instructions that do not include waiting at a hold location that is different from a customer delivery location. Such holding periods can be in response to hold instructions that are provided by any means described herein. Example discharge schedules consistent with the procedure of FIG. 10 can include any embodiment parent delivery vehicle receiving a discharge schedule from a processor module, such as the module in the scheduling server 128 illustrated in FIGS. 1C and 2, for example. The parent delivery vehicle may then execute the discharge schedule. Alternatively, the parent delivery vehicle may include a processor module on board that is configured to determine the discharge schedule based on mapping software, GPS functions, and receiving order or delivery information from various sources illustrated in FIG. 2, for example. Example discharge schedules consistent with the procedure 1000 are illustrated in FIG. 11.

FIG. 11 illustrates two discharge schedules 1168a and 1168b that can be executed using embodiment article delivery systems and methods. The discharge schedule 1168a includes discharging the child 104a at 5:00 AM for a delivery of grocery products to a first customer location at 7:00 AM. The schedule 1168a also includes discharging the child 104b at 5:15 AM for relatively immediate pickup of laundry at a second customer location at 5:20 AM.

The schedule 1168a also includes transporting the child 104b to a laundry service and discharging the child 104b for transfer of the laundry to the laundry service. Immediately thereafter, the parent delivery vehicle picks up the empty child 104b, such that the parent delivery vehicle remains at the discharge location for 104b. After picking up the child 104b, the parent returns to the first customer location after 7:00 AM for pickup of the child vehicle 104a.

In the discharge schedule 1168b, the parent 102 transports child vehicles 104a and 104b and discharges child 104a at 5:00 AM at a discharge location 1110a, for immediate navigation to a customer location 1118a for a 10:00 AM article delivery, for subsequent navigation to customer location 1118a′ at 11:00 AM. As a further part of what the child 104a executes after the discharge, the child 104a navigates back to the discharge location 1110a, for executing the hold instruction for pickup by the parent 102 around 2:00 PM.

The schedule 1168b executed by the parent 102 also includes the parent transporting and discharging the child 104b to a customer location 1118b (an apartment building) at 5:30 AM for navigation to the lobby of the apartment building to wait for laundry to be received and a package to be mailed from respective apartment customers anytime between 5:30 AM and 8:30 AM.

The schedule 1168b still further includes using the parent 102 to perform other child discharges and pickups between 5:30 AM and 8:30 AM. The schedule then includes picking up the child 104b after 8:30 AM, as well as picking up the child 104a around 2:00 PM. During the intervening time, it should be understood that the child 104b may further be used for other article deliveries, and the parent 102 may also discharge or pickup other child delivery vehicles that are not specified in the schedule 1168b.

In another example that is not illustrated in FIG. 11, an embodiment article delivery system may be employed in the manner delineated by the following sub-paragraphs (a)-(l):

(a) A customer A order is a request for a delivery at 6:20 am of groceries.

(b) A customer B order is a request for a pickup of wash-dry-fold between 7:00 am and 7:30 am.

(c) A watch repair shop order C is for delivery of three watches that were previously picked up by other parent-discharged child vehicles for repairs. The watch shop does not open until 10 am.

(d) The orders A, B, and C are made by the device 236, the terminal 238, and the terminal 234 illustrated in FIG. 2 and received by the cloud server 128 in FIG. 2.

(e) The server 128 determines that there will be a parent vehicle 102 (and driver, in a case in which parent 102 is human-operated) available at 3:30 am. The server 128 creates a discharge schedule that is set so that the parent leaves, at 3:30 am, a location where child vehicles have previously been loaded onto the parent. The schedule is for the parent 102 to discharge the three child vehicles in a sequence that minimizes driving time.

(f) The parent 102 is finished discharging vehicles by 4:00 am and is available for other work.

(g) A child vehicle used for order A wakes up five minutes before the requested grocery delivery time of 6:20 am and drives from a sidewalk hold location to a porch customer meeting point (customer location) and arrives by 6:20 am. The customer comes out a little later and removes all items. The customer also delivers one item into the child vehicle, for return, that was not previously known. The child vehicle drives back to the sidewalk hold location and awaits pickup by any available parent.

(h) The child vehicle for order B, after discharge from the parent, self-navigates directly to the customer meeting point (customer location), and when the customer arrives at the customer location, the customer loads (delivers) the customer's wash/dry/fold order bag into the child, and the child awaits pickup by any available parent vehicle.

(i) A child vehicle designated for order C waits outside a side door (hold location) to the jewelry store until the store owner (customer) retrieves the watches (articles) upon the store opening. The customer remotely controls (drives) the child vehicle, using a smartphone application, to a corner in the back of the store to wait.

(j) At the end of the day, two of the watches are repaired, and another item is ready to be returned to a store customer. These articles are placed in the child vehicle and the store owner drives the child out to the side door to await pickup by any available parent vehicle.

(k) For pickup scheduling, the server 128 identifies a free parent delivery vehicle truck and driver at 10 am and determines the traffic is sufficiently light. The server dispatches the truck parent with a number of other child delivery vehicles to be directed to other customers. During that same trip, the parent delivery vehicle truck picks up the two child vehicles A and B.

(l) Later in the same day, in the evening at 8 pm, the child vehicle C is picked up during a different trip by a different parent delivery vehicle.

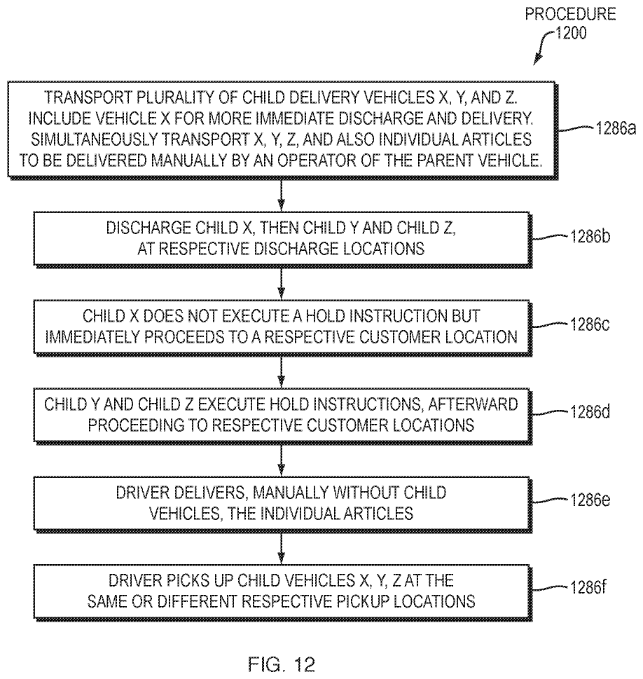

FIG. 12 is a flow diagram illustrating a procedure 1200 that can be followed by an article delivery system 100, and an operator of a corresponding parent delivery vehicle in the case of a human-operated parent vehicle. At 1286a, the parent delivery vehicle transports a plurality of child delivery vehicles labeled X, Y, and Z. Child vehicle X is designated for a more immediate discharge and delivery of a corresponding article held therein. The parent vehicle also carries individual articles to be delivered manually by the operator of the parent vehicle. Child vehicles X, Y, and Z are simultaneously transported to a first discharge location for the child X.

At 1286b, the parent delivery vehicle discharges child X, and then child Y and child Z, at respective discharge locations. After the discharge of child X, child Y and child Z are further transported simultaneously, while the transportation is no longer simultaneous with respect to child X. It should be understood, that embodiment systems and methods that include simultaneously transporting a plurality of child delivery vehicles, the simultaneous transportation need not be simultaneous during an entire discharge schedule for all of the plurality of child vehicles. It is sufficient for a parent delivery vehicle to transport child delivery vehicles simultaneously at some point during a discharge schedule, where simultaneous transportation is described herein.

At 1286c, child X does not execute a hold instruction, but instead immediately precedes to a respective customer location. At 1286d, child Y and child Z execute hold instructions, and then afterward, proceed to respective customer locations from the respective hold locations. At 1286e, the driver (operator) of the parent delivery vehicle delivers, manually, without child vehicles, the individual articles to be manually delivered. At 1286f, the driver picks up the child vehicles X, Y, and Z at respective pickup locations. Any of the respective pickup locations may be the same as, or different from, the respective discharge locations used at 1286b. As described hereinabove, pickup locations can be the same as discharge locations, hold locations, customer locations, or altogether different locations from any other locations used during the cycle of a given child vehicle, unless otherwise specified to differ.

In particular article delivery environments, such as where a holding location is inside a lobby, while a customer delivery location is a specific apartment inside the same building, a particular hotel room, or a particular location inside a high rise building, it can be advantageous to include additional functions on a particular child delivery vehicle that allow the child to navigate through the building. In one example, as an alternate to the hold location described in FIG. 7, which is outside the apartment building, a hold location may be inside a lobby of an apartment building. Where delivery to a particular apartment in the building is desirable, a child delivery vehicle can be provided with functions that permit this.

FIG. 13 is a side-view illustration of a child delivery vehicle 1304 configured to navigate using a building elevator with elevator doors 1307. The child vehicle 1304 includes a special actuator arm 1302 having a camera 1303 and actuator end 1304. The actuator end 1304 is designed to push elevator buttons 1305 in order to operate the elevator. The camera 1303 is configured to view the elevator buttons 1305 to permit the actuator and 1304 to push the correct button, such as to go up, to go down, to select the correct floor, etc. While one example holding location can be inside a lobby of the building, as described hereinabove, other hold locations can include a loading dock or another designated location.

Using the child vehicle 1304, when a delivery scheduled time approaches, the child 1304 can move toward the elevator doors 1307, navigate up to the correct floor for a customer location, and then navigate out into the hallway to the correct room or apartment. By waiting at a hold location (executing a hold instruction) other than the customer delivery location, child delivery vehicles need not be moving in a hallway at inconvenient times that are otherwise convenient for child discharge, such as 3:00 AM, for example. Child vehicles also need not clutter hallways. A customer still receives the advantage of articles coming directly to the customer, such that the customer can receive the articles at the customer's own room or apartment, and the customer does not have to go to a common area or carry the articles from the common area. This function can be useful not only in the situations described hereinabove, but also in other environments, such as a cruise ship.

In order to open an elevator for entry, the child delivery vehicle can request assistance from a human who passes nearby using a speaker. For example, the child delivery vehicle may state “could you please assist me and press the up button.” The child vehicle can also use image recognition, such as using the camera 1303 illustrated in FIG. 13, in order to recognize the correct button and use an actuator on the child vehicle to operate the button. In other embodiments, a remote operator can use the camera 1303 and remotely command the child vehicle to use the actuator end 1304 to press the correct elevator button. Similar functions of the child vehicle 1304 can be used on the elevator, for selecting the correct floor, for example, and for returning to the pickup point. In some embodiments, a remote operator is not used, and the child vehicle 1304 uses onboard machine vision functionality and a processor, in connection with the camera 1303, to command the actuator end 1304 to press the correct button. The child vehicle may simply drive forward to press an elevator button 1305 with the actuator end 1304. Alternatively, the actuator or actuator end may have a servo or other mechanism to move the actuator end into the elevator button.

Furthermore, it will be understood that a child delivery vehicle may have other functions, besides elevator-operating functions, that allow it to navigate in particular locations, as understood in the art of robotics and automated autonomous vehicles.

### Additional Embodiments

In an additional embodiment, an article delivery system includes a ground-based parent delivery vehicle and a child delivery vehicle configured to hold one or more articles for an article delivery to and from a customer location. The parent delivery vehicle is configured to carry the child delivery vehicle, to transport the child delivery vehicle to at least one discharge location, and to discharge the child delivery vehicle at a discharge location for delivery of the one or more articles at the customer location. The child delivery vehicle is configured to execute a hold instruction that includes waiting at the customer location following the discharge from the parent delivery vehicle and a delivery of an article to the customer location. The at least one child delivery vehicle is further configured to receive, following waiting at the customer location, one or more articles from the customer location.

The system can further include any system elements described hereinabove or hereinafter in connection with other embodiments.

In a corresponding additional embodiment method for article delivery, the method includes transporting, via a ground-based parent delivery vehicle, a child delivery vehicle to at least one discharge location for an article delivery to and from a customer location. The method further includes discharging the child delivery vehicle from the parent delivery vehicle at the discharge location. The method also includes executing, via the child delivery vehicle, a hold instruction including waiting at the customer location, following the discharging from the parent delivery vehicle and following a delivery of one or more articles to the customer location. The method still further includes receiving, following the executing the hold instruction, via the at least one child delivery vehicle, one or more articles for an article delivery from the customer location to the child delivery vehicle.

The method can further include, or be modified by, any embodiment method elements described hereinabove or hereinafter in connection with other embodiments.

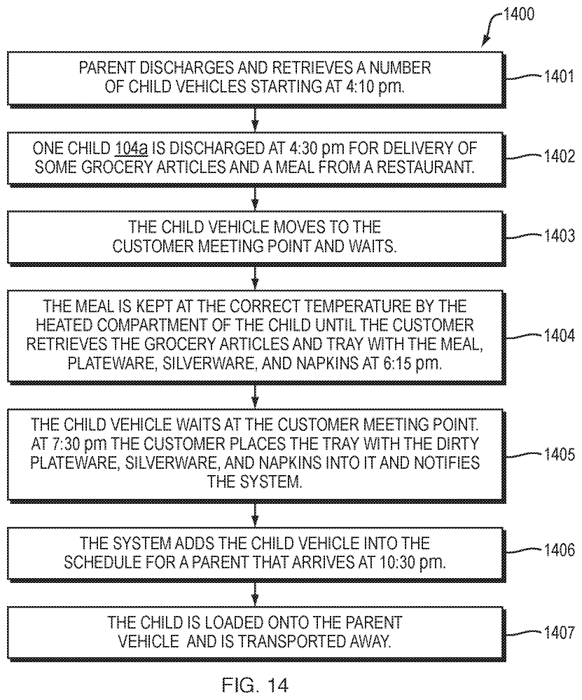

FIG. 14 is a flow diagram illustrating a procedure 1400 consistent with the additional embodiments described hereinabove. In the particular example procedure 1400, at 1401, a parent vehicle discharges and retrieves a plurality of child vehicles, beginning at 4:10 PM. At 1402, one child vehicle 104a, is discharged at 4:30 PM for delivery of some grocery articles and a meal from a restaurant.

At 1403, the child vehicle 104a moves (navigates) to the customer meeting point (customer location) and waits, executing a hold instruction.

At 1404, the meal is kept at the correct temperature, using a heated compartment, of the child vehicle, until the customer retrieves the grocery articles and tray with the meal, certain plateware and silverware, as well as napkins, at 6:15 PM. At 1405, the child vehicle 104a executes a hold instruction at the customer meeting point, while the customer dines on the meal. At 7:30 PM, the customer places the tray, with the dirty plateware, silverware, and napkins, into child 104a (the child receives these items via a delivery from the customer), and the customer notifies the child that deliver is complete.

At 1406, the system adds the child vehicle into a schedule for parent vehicle pickup that arrives at 10:30 PM. At 1407, the child vehicle 104a is loaded onto the parent vehicle and is transported away on the parent vehicle.

As will be understood, in view of this description, other situations where these additional embodiments can be useful include providing medical equipment to a patient to be used temporarily, such as dialysis equipment, delivering a new printer ink cartridge or toner cartridge to a customer, followed by receiving a delivery of the used cartridge from the customer into the child delivery vehicle for recycling, and other such situations. Such embodiment methods may be carried out by any of the embodiment article delivery systems described herein.

While this invention has been particularly shown and described with references to example embodiments thereof, it will be understood by those skilled in the art that various changes in form and details may be made therein without departing from the scope of the invention encompassed by the appended claims.

What is claimed is:

1. An article delivery system comprising:
a ground-based parent delivery vehicle; and
a plurality of child delivery vehicles configured to hold one or more articles for an article delivery to or from a customer location,
wherein the parent delivery vehicle is configured to carry the plurality of child delivery vehicles simultaneously, to transport the plurality of child delivery vehicles to at least one discharge location, and to discharge at least one of the plurality of child delivery vehicles at the at least one discharge location, and
wherein the at least one child delivery vehicle is configured to execute a hold instruction that includes waiting at a hold location following the discharge from the parent delivery vehicle, the at least one child delivery vehicle further configured to navigate, following waiting at the hold location, from the hold location to the customer location for the article delivery, the customer location differing from the hold location.

2. The system of claim 1, wherein the at least one child delivery vehicle is further configured to execute the hold instruction for an increase in an article delivery efficiency defined by a number of article deliveries per hour per parent delivery vehicle.

3. The system of claim 1, wherein the article delivery is a delivery of a product from the child delivery vehicle to the customer location.

4. The system of claim 1, wherein the article delivery is a delivery of a pickup article from the customer location to the at least one child delivery vehicle.

5. The system of claim 1, wherein the at least one child delivery vehicle is configured to execute the hold instruction at the hold location further with the hold location being the same as the at least one discharge location.

6. (canceled)

7. (canceled)

8. The system of claim 1, wherein the at least one child delivery vehicle is further configured to receive the hold instruction dynamically in response to at least one of a change in a scheduled customer pickup time, an availability of a customer, a communication to or from the customer, a child delivery vehicle discharge schedule of the parent delivery vehicle, and a change in a pickup schedule.

9. The system of claim 1, wherein the article delivery is a second article delivery subsequent to a first article delivery, and wherein the at least one child delivery vehicle is further configured to execute the hold instruction between the first and second article deliveries.

10. The system of claim 1, wherein the at least one child delivery vehicle is further configured to complete at least two deliveries of articles, following the discharge, at respective, scheduled article delivery times, either at the same customer location or at least two respective customer locations.

11. (canceled)

12. (canceled)

13. (canceled)

14. The system of claim 1, wherein the at least one child delivery vehicle includes a cooled or heated compartment.

15. (canceled)

16. (canceled)

17. The system of claim 1, wherein the hold instruction includes waiting at the hold location for at least 15 minutes, for at least 30 minutes, for at least one hour, or for at least three hours prior to navigating to the customer location.

18. (canceled)

19. A method for article delivery, the method comprising:
transporting, simultaneously, via a ground-based parent delivery vehicle, a plurality of child delivery vehicles to at least one discharge location for an article delivery to or from a customer location;
discharging at least one of the plurality of child delivery vehicles from the parent delivery vehicle at the least one discharge location;
executing, via the at least one child delivery vehicle, a hold instruction including waiting at a hold location, following the discharging from the parent delivery vehicle; and
navigating, following the executing the hold instruction, via the at least one child delivery vehicle, from the hold location to the customer location for the article delivery, the customer location differing from the hold location.

20. The method of claim 19, wherein executing the hold instruction includes increasing an article delivery efficiency defined by a number of article deliveries per hour per parent delivery vehicle.

21. The method of claim 19, wherein the article delivery is a product delivery, the method further including delivering the product, via the at least one child delivery vehicle, to the customer location.

22. The method of claim 19, wherein the article is a pickup article to be received from the customer location, the method further including receiving the pickup article, via the at least one child delivery vehicle, from the customer location to the at least one child delivery vehicle.

23. The method of claim 19, wherein executing the hold instruction includes waiting at the hold location, further with the hold location being the same as the at least one discharge location.

24. (canceled)

25. (canceled)

26. The method of claim 19, further including receiving the hold instruction dynamically, at the at least one child delivery vehicle, in response to at least one of a change in a scheduled customer pickup time, an availability of a customer, a communication to or from the customer, a child delivery vehicle discharge schedule of the parent delivery vehicle, and a change in a child delivery vehicle pickup schedule for the parent delivery vehicle.

27. The method of claim 19, wherein the article delivery is a second article delivery subsequent to a first article delivery, and wherein executing the hold instruction includes waiting at the hold location between the first and second article deliveries.

28. The method of claim 19, wherein the article delivery is a first article delivery, the method further including completing a second article delivery, via the at least one child delivery vehicle, the first and second article deliveries occurring at respective, scheduled article delivery times, either at the same customer location or at two respective customer locations.

29. (canceled)

30. (canceled)

31. (canceled)

32. The method of claim 19, further including heating or cooling, via the at least one child delivery vehicle, an article delivered or received.

33. (canceled)

34. (canceled)

35. The method of claim 19, wherein executing the hold instruction includes waiting at the hold location for at least 15 minutes, for at least 30 minutes, for at least one hour, or for at least three hours before the navigating to the customer location.

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)
